(19) United States
(12) Patent Application Publication
(10) Pub. No.: US 2012/0028794 A1
(43) Pub. Date: Feb. 2, 2012

(54) CATALYSTS FOR THE PRODUCTION OF HYDROGEN

(76) Inventors: Khiet Thanh Lam, Houston, TX (US); Brendan Dermot Murray, Houston, TX (US); Narayana Mysore, Houston, TX (US); Scott Lee Wellington, Bellaire, TX (US)

(21) Appl. No.: 13/141,248

(22) PCT Filed: Dec. 17, 2009
(86) PCT No.: PCT/US2009/068448

§ 371 Date: Sep. 14, 2011

Related U.S. Application Data
(60) Provisional application No. 61/140,364, filed on Dec. 23, 2008.

(51) Int. Cl. B01J 23/00; B01J 37/00; B01J 23/755; B01J 37/08; B01J 35/02; B01J 23/10

(52) U.S. Cl. 502/303; 502/300; 502/325; 502/337

(57) ABSTRACT

The invention provides a bio-based feedstock steam reforming catalyst comprising: a modified support; a metal component; and a promoter. The process also provides a method of preparing a bio-based feedstock steam reforming catalyst comprising: providing a support material comprising a transition metal oxide; providing a modifier comprising an alkaline earth element; contacting the support material with the modifier to form a modified support; providing a metal component comprising a Group VIII transition metal; contacting the support material, the modified support or combinations thereof with the metal component to form the steam reforming catalyst; and contacting the modified support, the metal component, the steam reforming catalyst or combinations thereof with a promoter.

This application claims priority to U.S. Provisional Application No. 61/140,364, filed on Dec. 23, 2008, which is herein incorporated by reference.

### FIELD

The invention relates to the production of hydrogen through steam reforming processes and catalysts for use therein.

### BACKGROUND

As reflected in the patent literature, the production of electrical power in the most efficient manner with minimal waste is the focus of much research. For example, it is desirable to improve the efficiency in the production of electricity, separate and either use by-product carbon dioxide (CO₂) in other processes and/or minimize the CO₂ production. Attempts to minimize CO₂ production have included “boosting” the effectiveness of fuels by adding hydrogen to improve fuel efficiency. Other attempts have included producing electricity in fuel cells utilizing pure hydrogen rather than hydrocarbon based fuels. However, the production of such hydrogen has still generated significant CO₂ both in the hydrogen production process and in the production of the feedstocks utilized to form the hydrogen.

Common approaches for producing hydrogen include steam reforming, catalytic partial oxidation and autothermal reforming, for example. Partial oxidation systems are based on combustion. Decomposition of the feedstock to primarily hydrogen and carbon monoxide (CO) occurs through thermal cracking reactions at high temperatures. Catalytic partial oxidation (CPO) catalytically reacts the feedstock with oxygen to produce primarily hydrogen and carbon monoxide. Autothermal reforming is a variation on catalytic partial oxidation in which increased quantities of steam are used to promote steam reforming and reduce coke formation. CPO and steam reforming reactions are used in combination such that the heat from the CPO reaction can be utilized by the steam reforming reaction.

Steam reforming of hydrocarbon based feeds, such as methane and natural gas, has generally been the most cost effective process for the production of large volumes of hydrogen. However, the economics of natural gas reforming is strongly impacted by the cost of natural gas. Further, a large amount of carbon dioxide is produced from steam methane reforming (SMR), resulting in a large CO₂ footprint on the environment.

Efforts have been made to reduce the CO₂ footprint by utilizing renewable feedstocks, such as biology based feeds, in the hydrogen production process. However, such feedstocks have generally resulted in process inefficiency and significantly decreased conversion levels within conventional steam reforming processes. Further, conventional steam reforming catalysts have typically experienced deactivation upon contact with such renewable feedstocks, making them unviable for hydrogen production.

Therefore, it is desirable to develop processes for electricity production (and hydrogen production) whereby the CO₂ footprint is minimized while maintaining process conversion and efficiency.

### SUMMARY

The invention provides a bio-based feedstock steam reforming catalyst comprising: a modified support; a metal component; and a promoter.

The invention also provides a method of preparing a bio-based feedstock steam reforming catalyst comprising: providing a support material comprising a transition metal oxide; providing a modifier comprising an alkaline earth element; contacting the support material with the modifier to form a modified support; providing a metal component comprising a Group VIII transition metal; contacting the support material, the modified support or combinations thereof with the metal component to form the steam reforming catalyst; and contacting the modified support, the metal component, the steam reforming catalyst or combinations thereof with a promoter.

### BRIEF DESCRIPTION OF FIGURES

FIG. 1 illustrates the concentration of hydrogen in the product gas produced during Run 9.

FIG. 2 illustrates the concentration of methane in the product gas produced during Run 9.

FIG. 3 illustrates the concentration of carbon dioxide in the product gas produced during Run 9.

FIG. 4 illustrates the concentration of carbon monoxide in the product gas produced during Run 9.

### DETAILED DESCRIPTION

A detailed description will now be provided. Each of the appended claims defines a separate invention, which for infringement purposes is recognized as including equivalents to the various elements or limitations specified in the claims. Depending on the context, all references below to the “invention” may in some cases refer to certain specific embodiments only. In other cases it will be recognized that references to the “invention” will refer to subject matter recited in one or more, but not necessarily all, of the claims. Each of the inventions will now be described in greater detail below, including specific embodiments, versions and examples, but the inventions are not limited to these embodiments, versions or examples, which are included to enable a person having ordinary skill in the art to make and use the inventions when the information in this patent is combined with available information and technology.

Various terms as used herein are shown below. To the extent a term used in a claim is not defined below, it should be given the broadest definition skilled persons in the pertinent art have given that term as reflected in printed publications and issued patents at the time of filing. Further, unless otherwise specified, all compounds described herein may be substituted or unsubstituted and the listing of compounds includes derivatives thereof.

Various ranges are further recited below. It should be recognized that unless stated otherwise, it is intended that the endpoints are to be interchangeable. Further, any point within that range is contemplated as being disclosed herein.

Embodiments of the invention generally include processes for producing hydrogen. The processes generally include contacting steam and a feedstock with a steam reforming catalyst disposed within a reformer to form a reformate rich in hydrogen. In particular, embodiments of the invention provide steam reforming catalysts capable of use in reforming processes without sensitivity to change in feed that exhibit increased selectivity.

One or more embodiments utilize a biology based, hereinafter referred to as “bio-based,” feedstock. It is desirable to utilize bio-based feedstocks in an effort to decrease fuel costs (e.g., the cost of producing the feedstock), minimize impacts to the environment (both in the production of the feedstock and the use thereof) and provide sustainable feedstocks for hydrogen production, for example.

The bio-based feedstock may include alcohols, acids, ketones, ethers, esters, aldehydes or combinations thereof, for example. The alcohols may include methanol, ethanol, n-propanol, isopropyl alcohol, butanol or combinations thereof, for example. In one or more embodiments, the alcohol is ethanol (which may be referred to herein as bio-based ethanol when required to distinguish from hydrocarbon derived ethanol). The acids may include acetic acid, for example. The ketones may include acetone, for example.

In one or more embodiments, the bio-based feedstock is derived from biomass, such as lignin, corn, sugar cane, syrup, beet juice, molasses, cellulose, sorbitol, algae, glucose, acetates, such as ethyl acetate or methyl acetate or combinations thereof. As used herein, the term “biomass” excludes organic material which has been transformed by geological processes into substances, such as petroleum. In one or more embodiments, the bio-based feedstock is derived from biogas, such as that produced by anaerobic digestion or fermentation of biodegradable materials, including biomass, manure, sewage, energy crops or combinations thereof, for example. As used herein, the term “biogas” refers to a gas produced by the biological breakdown of organic matter in the absence of oxygen.

In one or more embodiments, the feedstock includes an oxygenate. As used herein, the term “oxygenate” refers to a compound containing at least one oxygen atom. It is contemplated that the oxygenates may be petroleum based or may be bio-based. However, one or more embodiments include bio-based oxygenates. In one specific embodiment, the bio based oxygenate is selected from acetone, acetic acid, n-propanol, isopropanol, ethyl acetate, methyl acetate, butanol, ethanol and combinations thereof, for example.

It is contemplated that the processes described herein can reduce the carbon footprint of hydrogen production. For example, bio-based feedstocks can have a reduced carbon footprint compared to fossil fuels due to their reduction of CO₂ production during their lifespan

In addition to the feedstock, water (e.g., in the form of steam) is introduced into the reformer. A majority of reforming processes include contacting the water and the feedstock, vaporizing the water, prior to entry into the reformer. However, it is contemplated that water may be introduced into the reformer separately from the feedstock.

Currently, ethanol is the most widely available bio-based feedstock. Production of bio-based ethanol generally includes fermentation and yields ethanol diluted with large amounts of water. For example, a “fuel” fermentation broth may have an ethanol content of less than 10 wt. %. Accordingly, bio-based ethanol is generally treated to remove at least a portion of the water prior to delivery. Treatment methods for removal of the water to produce fuel grade and chemical grade ethanol may include distillation and further separation of the water, such as via zeolite adsorption, for example. The cost of treatment significantly adds to the production cost of bio-based ethanol. For example, the treatment processes may result in over 50 percent of the actual utility cost in producing bio-based ethanol from fermentation based processes.

However, it has been discovered that extensive water removal from the fermentation broth is not necessary for operation with the embodiments described herein. In fact, it has been observed that aqueous feedstocks may increase the efficiency of the described reforming processes (and minimize or eliminate the need for separate water introduction into the reformer). Accordingly, one or more embodiments utilize aqueous bio-based feedstocks. The aqueous bio-based feedstock may include at least 5 wt. %, or at least 15 wt. %, or at least 20 wt. %, or at least 30 wt. %, or from 10 wt. % to 90 wt. % or from 20 wt. % to 80 wt. % water, for example.

It is common for bio-based feedstocks, such as bio-based alcohols, to include one or more denaturing agents. As used herein, the term “denaturing agent” refers to a compound utilized to render a feedstock toxic or undrinkable. Unfortunately, it has been observed that some denaturing agents can further decrease conversion of reforming processes. As used herein, the term “conversion” refers to the ability of a catalyst to convert the feed to products other than the feed. However, the extent of the decrease in conversion appears dependent upon the type of denaturing agent. For example, it has been observed that benzene, when utilized as a denaturing agent, can lead to a loss of catalyst activity (measured by the weight of hydrogen produced per weight of steam reforming catalyst used) and a resulting decrease in conversion. In contrast, methanol can be utilized as a denaturing agent with little to no effect on the catalyst activity (e.g., a reduction in catalyst activity of less than 5 percent, or less than 3 percent or less than 1 percent compared to an identical feedstock absent the denaturing agent). However, even when catalyst deactivation (i.e., loss of catalyst activity) occurs as a result of the denaturing agent, it has unexpectedly been observed that this deactivation can be reversed with one or more embodiments of the invention by switching the denaturing agent in the feedstock (without replacing the steam reforming catalyst). Accordingly, one or more embodiments of the invention result in reforming processes having little to no sensitivity to feedstock change (e.g., catalyst activity can be restored to commercially viable levels upon change of feedstock without shutdown of the reformer). Commercially viable catalyst activity levels depend upon and are determined by individual process parameters.

The reformer may include any reactor (or combination of reactors) capable of steam reforming a feedstock to produce a reformate including hydrogen. For example, the reactor may include a gas phase reactor (e.g., the feedstock is introduced into the reformer as vapor). Such processes are referred to herein as steam reforming processes. While it is desirable to utilize existing equipment to employ the embodiments described herein, it is contemplated that new plants/equipment may be designed and built to optimize the embodiments described herein.

Chemical equilibrium and heat transfer limitations are two factors governing the production of hydrogen within reforming processes. It is desirable to design and operate the reformer in a manner such that chemical equilibrium is reached, thereby resulting in maximum hydrogen production.

Historically, steam reformers (such as those utilizing methane and petroleum based ethanol feedstocks) have operated at high temperatures of at least 900° C., for example, to promote the forward equilibrium reaction and maintain sufficient process efficiency. As used herein, the term “efficiency” is measured per pass through the reformer by the following equation: (g H₂ product)/(g feed+net thermal heat+net power consumption).

Heat is generally supplied to the reformer from a heat source. The heat source may include those capable of supplying heat to steam reformers. However, one embodiment includes flameless distributed combustion (FDC). FDC enables efficient use of system energy and is generally accomplished by pre-heating combustion air and fuel gas sufficiently such that when the two streams are combined, the temperature of the mixture exceeds the auto-ignition temperature of the mixture. However, the temperature of the mixture is generally lower than that which would result in oxidation reactions upon mixing. See, U.S. Pat. No. 6,821,501 and U.S. Pat. Publ. No. 2006/0248800, which are incorporated by reference herein.

In one or more embodiments, the reformer may be operated at a reformer operation pressure of less than 300 psig, from 100 psig to 400 psig, or from 200 psig to 400 psig, or from 200 psig to 240 psig, or from 150 psig to 275 psig or from 150 psig to 250 psig, for example.

As discussed herein, the reformate is generally hydrogen rich (i.e., includes more than 50 mol. % hydrogen). In one or more embodiments, the reformate includes at least 60 mol. %, or at least 70 mol. %, or at least 95 mol. % or at least 97 mol. % hydrogen relative to the total weight of the reformate, for example. In addition to hydrogen, the reformate may further include by-products, such as carbon monoxide.

Additional hydrogen can be produced via a water gas shift reaction that converts carbon monoxide (CO) into carbon dioxide (CO₂). Therefore, the reformate may optionally be passed to a water-gas shift reaction zone where the process stream (e.g., the reformate) is further enriched in hydrogen by reaction of carbon monoxide present in the process stream with steam in a water-gas shift reaction to form a water-gas shift product stream having a greater hydrogen concentration than a hydrogen concentration of the reformate. For example, the water-gas shift product stream may include at least 97 mol. %, or at least 98 mol. % or at least 99 mol. % hydrogen relative to the weight of the water-gas shift product stream.

The water-gas shift reaction zone may include any reactor (or combination of reactors) capable of converting carbon monoxide to hydrogen. For example, the reactor may include a fixed-bed catalytic reactor. The water-gas shift reactor includes a water-gas shift catalyst. The water-gas shift catalyst may include any catalyst capable of promoting the water-gas shift reaction. For example, the water-gas shift catalyst may include alumina, chromia, iron, copper, zinc, the oxides thereof or combinations thereof. In one or more embodiments, the water-gas shift catalyst includes commercially available catalysts from BASF Corp, Sud Chemie or Haldor Topsoe, for example.

The water-gas shift reaction generally goes to equilibrium at the temperatures required to drive the reforming reaction (therefore, hindering the production of hydrogen from carbon monoxide). Therefore, the water-gas shift reactor typically operates at an operation temperature that is lower than reformer operation temperature (e.g., at least 50° C. less, or at least 75° C. less or at least 100° C. less). For example, the water-gas shift reaction may occur at a temperature of from about 200° C. to about 500° C., or from 250° C. to about 475° C. or from 275° C. to about 450° C., for example.

In one or more embodiments, the water-gas shift reaction is operated in a plurality of stages. For example, the plurality of stages may include a first stage and a second stage.

Generally, the first stage is operated at a temperature that is higher than that of the second stage (e.g., the first stage is high temperature shift and the second stage is a low temperature shift). In one or more embodiments, the first stage may operate at a temperature of from 350° C. to 500° C., or from 360° C. to 480° C. or from 375° C. to 450° C., for example. The second stage may operate at a temperature of from 200° C. to 325° C., or from 215° C. to 315° C. or from 225° C. to 300° C., for example. It is contemplated that the plurality of stages may occur in a single reaction vessel or in a plurality of reaction vessels.

It has been observed that many of the steam reforming catalyst optimized for petroleum based reforming processes (such as those utilized in steam methane reforming) do not provide sufficient conversion when reacted with ethanol (either bio-based or petroleum based) and/or other bio-based feedstocks. Desirably, the steam reforming process proceeds via dehydrogenation. However, a second reaction pathway may occur and includes dehydration. Dehydrogenation reaction pathways generally result in the ability of the reformate to undergo subsequent water-gas shift reactions at temperatures lower than the temperatures attainable with dehydration reaction pathways; thereby maximizing hydrogen production. In contrast, dehydration of ethanol leads to ethylene as a reactive intermediate, thereby increasing the potential for coke production (e.g., carbon deposits) within the reformer.

Coke buildup can result in lower steam reforming catalyst activity and therefore a shortened catalyst lifetime. Efforts to retard the dehydration reaction pathway have included utilizing high molar steam to carbon ratios (e.g., greater than 6:1) to increase hydrogen selectivity, thereby significantly increasing reforming heating costs. As used herein, the term “selectivity” refers to the percentage of feedstock converted to hydrogen. However, embodiments of the invention are capable of operation at lower molar steam to carbon ratios (e.g., less than 6:1) without the resulting loss in catalyst activity and increase in coke formation. For example, embodiments of the invention may utilize a steam to carbon (as measured by the carbon content in the feedstock) molar ratio of from 2.0:1 to 5:1, or from 2.5:1 to 4:1 or from 2.75:1 to 4:1, for example.

In addition to lower steam to carbon ratios, embodiments of the invention are capable of lower reformer operation temperatures, e.g., reformer operation temperatures of less than 900° C., or less than 875° C., or less than 850° C., or from 500° C. to 825° C. or from 600° C. to 825° C., for example, while maintaining adequate process efficiency (e.g., efficiencies within 20 percent, or 15 percent or 10 percent of the efficiency of an identical process operated at high temperatures). In some instances, the embodiments of the invention are capable of operation at lower reformer temperatures while exhibiting increased process efficiencies over identical processes operated at high reformer temperatures. For example, the embodiments of the invention may exhibit efficiencies of at least 5 percent greater, or at least 7 percent greater or at least 10 percent greater than identical high temperature processes.

Lower reformer temperatures (i.e., temperatures of less than 900° C.) can result in a lower utilities demand, lower construction material cost (due at least in part to a reduction in corrosion and stress on process equipment), a reduced CO₂ footprint (e.g., decreased CO₂ levels in the reformate), more favorable water gas shift equilibrium and increased hydrogen levels in the reformate, for example.

In one or more embodiments, the reformer includes a membrane type reactor, such as that disclosed in U.S. Pat. No. 6,821,501, which is incorporated by reference herein. The in-situ membrane separation of hydrogen employs a membrane fabricated from an appropriate metal or metal alloy on a porous ceramic or porous metal support. Removal of hydrogen through the membrane allows the reformer to be run at temperatures lower than conventional processes. For example, the membrane type reactor may be operated at a temperature of from 250° C. to 700° C., or from 250° C. to 500° C. or from 250° C. to 450° C. It has been observed that such reformer operation temperatures provide for CO₂ selectivity (over CO selectivity) of near 100 percent, while higher temperatures, such as those utilized in conventional processes provide for greater CO selectivity.

The membrane type reactor is generally operated at pressures sufficient to favor equilibrium. Moreover, such pressures drive the hydrogen through the membrane of the reformer.

It has been observed that reforming processes utilizing membrane type reactors are capable of producing hydrogen of high purity (e.g., at least 95 mol. % or at least 96 mol. %). Accordingly, one or more embodiments utilize a membrane type reactor, thereby eliminating the use of water gas shift reactions to further purify the reformate. The hydrogen is recovered as permeate without additional impurities that might affect performance in subsequent use. The remaining stream generally includes high concentration CO₂.

The reactor annulus is packed with steam reforming catalyst and equipped with a perm-selective (i.e., hydrogen-selective) membrane that separates hydrogen from the remaining gases as they pass through the catalyst bed. The membrane is generally loaded with the steam reforming catalyst.

Membranes suitable for use in the present invention include various metals and metal alloys on a porous ceramic or porous metallic supports. The porous ceramic or porous metallic support protects the membrane surface from contaminants and, in the former choice, from temperature excursions. In one or more embodiments, the membrane support is porous stainless steel. Alternatively, a palladium layer can be deposited on the outside of a porous ceramic or metallic support, in contact with the steam reforming catalyst.

The high purity hydrogen may be used directly in a variety of applications, such as petrochemical processes, without further reaction or purification. However, the reforming process may further include purification. The purification process may include separation, such as separation of the hydrogen from the reformate or water-gas shift product stream, to form a purified hydrogen stream. For example, the separation process may include absorption, such as pressure swing absorption processes which form a purified hydrogen stream and a tail gas. Alternatively, the separation process may include membrane separation to form a purified hydrogen stream and a carbon dioxide rich stream. One or more embodiments include both absorption and membrane separation.

The purified hydrogen stream may include at least 95 wt. %, or at least 98 wt. % or at least 99 wt. % hydrogen relative to the weight of the purified hydrogen stream, for example.

As described above, the feedstock generally contacts a steam reforming catalyst within the reformer, accelerating the formation of hydrogen. The steam reforming catalyst may include those catalysts capable of operating at equilibrium under steam reforming operation conditions. For example, the steam reforming catalyst may include those catalysts capable of operating at equilibrium under reformer operation temperatures of less than 900° C. In one or more embodiments, the steam reforming catalyst is selective to the dehydrogenation reaction pathway when utilizing ethanol as the feedstock (either petroleum based or bio-based).

The steam reforming catalyst generally includes a support material and a metal component, which are described in greater detail below. The “support material” as used herein refers to the support material prior to contact with the metal component and a “modifier”, also discussed in further detail below.

The support material may include transition metal oxides or other refractory substrates, for example. The transition metal oxides may include alumina (including gamma, alpha, delta or eta phases), silica, zirconia or combinations thereof, such as amorphous silica-alumina, for example. In one specific embodiment, the transition metal oxide includes alumina. In another specific embodiment, the transition metal oxide includes gamma alumina.

The support material may have a surface area of from 30 m²/g to 500 m²/g, or from 40 m²/g to 400 m²/g or from 50 m²/g to 350 m²/g, for example. As used herein, the term “surface area” refers to the surface area as determined by the nitrogen BET (Brunauer, Emmett and Teller) method as described in Journal of the American Chemical Society 60 (1938) pp. 309-316. As used herein, surface area is defined relative to the weight of the support material, unless stated otherwise.

The support material may have a pore volume of from 0.1 cc/g to 1 cc/g, or from 0.2 cc/g to 0.95 cc/g or from 0.25 cc/g to 0.9 cc/g, for example. In addition, the support material may have an average particle size of from 0.1μ to 20μ, or from 0.5μ to 18μ or from 1μ to 15μ (when utilized as in powder form), for example. However, it is contemplated that the support material may be converted into particles having varying shapes and particle sizes by pelletization, tableting, extrusion or other known processes, for example.

In one or more embodiments, the support material is a commercially available support material, such as commercially available alumina powders including, but not limited to, PURAL® Alumina and CATAPAL® Alumina, which are high purity bohemite aluminas sold by Sasol Inc.

The metal component may include a Group VIII transition metal, for example. As used herein, the term “Group VIII transition metal” includes oxides and alloys of Group VIII transition metals. The Group VIII transition metal may include nickel, platinum, palladium, rhodium, iridium, gold, osmium, ruthenium or combinations thereof, for example. In one or more embodiments, the Group VIII transition metal includes nickel. In one specific embodiment, the Group VIII transition metal includes nickel salts, such as nickel nitrate, nickel carbonate, nickel acetate, nickel oxalate, nickel citrate or combinations thereof, for example.

The steam reforming catalyst may include from about 0.1 wt. % to 60 wt. %, from 0.2 wt. % to 50 wt. % or from 0.5 wt. % to 40 wt. % metal component (measured as the total element, rather than the transition metal) relative to the total weight of steam reforming catalyst, for example.

One or more embodiments include contacting the support material or steam reforming catalyst with a modifier to form a modified support or modified steam reforming catalyst (which will be referred collectively herein as modified support). For example, the modifier may include a modifier exhibiting selectivity to hydrogen.

In one or more embodiments, the modifier includes an alkaline earth element, such as magnesium or calcium, for example. In one or more specific embodiments, the modifier is a magnesium containing compound. For example, the magnesium containing compound may include magnesium oxide or be supplied in the form of a magnesium salt (e.g., magnesium hydroxide, magnesium nitrate, magnesium acetate or magnesium carbonate).

The steam reforming catalyst may include from 0.1 wt. % to 15 wt. %, or from 0.5 wt. % to 14 wt. % or from 1 wt. % to 12 wt. % modifier relative to the total weight of support material, for example.

The modified support may have a surface area of from 20 m²/g to 400 m²/g, or from 25 m²/g to 300 m²/g or from 25 m²/g to 200 m²/g, for example.

In one or more embodiments, the steam reforming catalyst further includes one or more additives. In one or more embodiments, the additive is a promoter, for example.

The promoter may be selected from rare earth elements, such as lanthanum. The rare earth elements may include solutions, salts (e.g., nitrates, acetates or carbonates), oxides and combinations thereof, for example.

The steam reforming catalyst may include from 0.1 wt. % to 15 wt. %, from 0.5 wt. % to 15 wt. % or from 1 wt. % to 15 wt. % additive relative to the total weight of steam reforming catalyst, for example.

In one or more embodiments, the steam reforming catalyst includes a greater amount of additive than modifier. For example, the steam reforming catalyst may include at least 0.1 wt. %, or at least 0.15 wt. % or at least 0.5 wt. % more additive than modifier. In another embodiment, the steam reforming catalyst includes substantially equivalent amounts of additive and modifier, for example.

Embodiments of the invention generally include contacting the support material (either modified or unmodified depending on the embodiment) with the metal component to form the steam reforming catalyst. The contact may include known methods, such as co-mulling the transition metal with the support material or impregnating the metal component into the support material.

One or more embodiments include a plurality of contact steps. For example, embodiments utilizing at least 10 wt. %, or at least 15 wt. % or at least 20 wt. % metal component relative to the total weight of catalyst may utilize a plurality of contact steps. In one or more embodiments, the catalyst preparation may include a sequence of contacting the support material and the metal component, drying the resulting compound and contacting the dried resulting compound with additional metal component, support material or combinations thereof.

The support material may be modified by contacting the support material with the modifier to form the modified support. Such contact can occur via known methods, such as by co-mulling the support material with the modifier, ion exchanging the support material with the modifier or impregnating the modifier within the support material, for example.

It is contemplated that one or more of the steps, such as contact of the support material with the modifier and the metal component, may be combined into a single step.

In one or more embodiments, the modified support is formed into particles. The particles may be formed by known methods, such as extrusion, pelleting or tableting, for example.

In one or more embodiments, the modified support material is dried. The modified support material may be dried at a temperature of from 150° C. to 400° C., or from 175° C. to 400° C. or from 200° C. to 350° C., for example.

In one or more embodiments, the steam reforming catalyst, the modified support or combinations thereof is calcined. It has been observed that calcinations at high temperatures (e.g., greater than 900° C.) may result in significant loss of surface area (e.g., resulting in surface areas as low as 10 m²/g). Accordingly, the calcinination may occur at a temperature of from 400° C. to 900° C., 400° C. to 800° C. or from about 400° C. to 700° C., for example. It has been observed that calcining results in a steam reforming catalyst that is stronger and more resistant to crushing. Further, calcination results in retardation of stream reforming catalyst deactivation within reforming processes, significantly increasing the steam reforming catalyst life over those catalysts not undergoing calcination. In addition, it has been observed that calcination of the modified support increases the surface area of the support material, thereby providing for greater metal component incorporation therein. For example, the surface area may increase at least 5 percent, or at least 7 percent or at least 10 percent over the surface area of the same modified support absent calcination.

One or more embodiments include a plurality of calcinations steps. For example, the catalyst preparation may include a sequence of calcining, drying and calcining.

In one or more embodiments, the modified support, the metal component, the steam reforming catalyst or combinations thereof are contacted with the one or more additives. The contact may include known methods, such as co-mulling, ion exchange or impregnation methods, for example.

While the reactions described herein have, in theory, the ability to produce a predetermined amount of hydrogen (the theoretical yield), the actual processes are constrained to producing hydrogen at a rate that is lower than the hypothetical yield. However, the processes described herein unexpectedly result in a conversion rate that is significantly greater than that of traditional processes (e.g., processes utilizing conventional steam reforming catalysts to convert ethanol to hydrogen at high temperatures). For example, the processes described herein result in a hydrogen yield (percentage of theoretical yield) of at least 60 percent, or at least 65 percent, or at least 70 percent, or at least 75 percent, or at least 80 percent, or at least 85 percent or at least 90 percent, for example. The processes may further exhibit an efficiency of at least 70 percent, or at least 75 percent, or at least 80 percent, or at least 85 percent or at least 90 percent, for example.

The hydrogen produced by the processes described herein may be utilized for any process requiring substantially pure hydrogen. For example, the hydrogen may be utilized in petrochemical processes or for fuel cells, for example.

A fuel cell is an energy conversion device that generates electricity and heat by electro-chemically combining a gaseous fuel, such as hydrogen, and an oxidant, such as oxygen, across an ion-conducting electrolyte. The fuel cell converts chemical energy into electrical energy. The use of fuel cells reduce emissions through their much greater efficiency, and so require less fuel for the same amount of power produced compared to conventional hydrocarbon fueled engines.

In one or more embodiments, the CO₂ produced by the formation of hydrogen may be utilized for high pressure injection into applications, such as oil recovery. Such applications enhance the oil and gas recovery process, while at the same time minimizing the carbon impact on the environment (the carbon monoxide/dioxide is turned into a non-volatile component within the earth).

It is further contemplated that the CO₂ formed by the processes described herein may be utilized in sequestration processes. For example, the CO₂ may be permanently stored so as to prevent release into the atmosphere.

### EXAMPLES

### Example 1

Two microreactors including high Ni alloy reactor tubes were utilized to study the effect of various feedstocks and steam reforming catalyst on the gas phase steam reforming processes. Each reactor was supplied by a 3 gallon feed can fitted with a stainless steel diptupe. A teflon encapsulated VITON o-ring and a vacuum closure lid were used to seal the feed cans in order to eliminate vapor loss. The feed cans were maintained at 5-10 psig nitrogen pressure to minimize exposure to air and to provide a positive pressure to convey the feed to an HPLC pump.

Feedstock A refers to 30 wt. % ethanol in deionized water.

Feedstock B refers to methane (without added ethanol). The methane gas was supplied from pressurized cylinders obtained commercially from Airgas. When Feedstock B was used (see, Runs 1-4), 3.33 L/Hr of methane and 8.26 g/Hr of water was passed over the catalyst (molar steam to carbon ratio of 3:1).

Feedstock C refers to a mixture of 30 wt % ethanol, 70% natural gas in deionized water. To obtain different molar steam to carbon ratios of Feedstock B ranging between 2:1 and 6:1, the amount of deionized water used was adjusted. Higher amounts of water were used to obtain higher molar steam to carbon ratios with Feedstock B.

Catalyst A refers to a nickel catalyst containing 56 wt. % NiO supported on a mixture containing Al₂O₃, SiO₂ and MgO, commercially available from Sud Chemie as C11-PR. Catalyst A was supplied in the form of 4.7 mm×4.7 mm tablets that were crushed and sized to 20 mesh before loading into the microreactors.

Catalyst B refers to a lanthanum promoted nickel catalyst having magnesium oxide impregnated into an alumina support. 500 g of Catalyst B was prepared by co-mulling Mg(OH)₂, lanthanum nitrate hexahydrate (obtained from Aldrich Chemical Co.) and deionized water into CATAPAL® B Alumina (obtained from Sasol North America) in a Lancaster mix muller. The well mix-mulled powder was then extruded as a wet paste into the form of 1.6 mm cylindrical extrudates. The extrudates were dried at 120° C. for 16 hours and then calcined in air at 550° C. for 3 hours. The extrudate was allowed to cool to room temperature and then impregnated with Ni nitrate hexahydrate (obtained from Aldrich Chemical Co.). The Ni impregnated catalyst was dried and then calcined in air at 700° C. for 2 hours. It was analyzed and found to contain (dry basis), 18 wt. % NiO, 12 wt. % MgO, 12 wt. % La₂O₃ and the remaining balance Al₂O₃.

Each reactor was disassembled, cleaned with toluene and then dried with flowing nitrogen in a ventilated hood. The thermowell was screwed into the head and tightened. The reactor was positioned in a vise, with the bottom end facing up. The reactor was then loaded with catalyst from the bottom. A small, slotted metal spacer was placed over the thermowell and pushed down the length of the tube. A bed of silicon carbide (20 mesh) was added so that when the catalyst bed was loaded, it will reside near zone three and the top of zone four in the four zone furnace. After the 20 mesh silicon carbide was loaded, another small spacer was added to hold the silicon carbide in place. A total of 20 grams of steam reforming catalyst was divided into four equal parts and mixed evenly with an equal weight of 60-80 mesh silicon carbide. The four equal portions of catalyst and diluent were poured into the reactor tube while it was gently tapped. After the catalyst/silicon carbide mixture was loaded, another spacer was inserted into the reactor. Enough 20 mesh silicon carbide was then added to nearly fill the reactor. The remaining void was filled with a final small, slotted metal spacer. Once the reactor tube was properly filled, the top reactor head was finally installed and the multi-point gut thermocouple was inserted into the thermowell of the reactor.

The reactor tube was then placed in the furnace and a nitrogen flowrate of 10 liters/hour was established to purge the reactor of air. The nitrogen was stopped after 1 hour and replaced with hydrogen. The catalyst bed was heated to the desired bed temperature at a heating rate of 50° C. per hour and allowed to equilibrate for 16 hours. The catalyst bed temperature was adjusted (if necessary) and the reactor was pressurized slowly to the desired testing pressure, 200 psig or 340 psig. The liquid feed was introduced at the desired feed rate of from 0.4 to 1.2 mL/min. The reaction products were analyzed by gas chromatography to determine the overall conversion and selectivity of the catalyst.

### Runs 1-4

Conditions: molar steam to carbon ratio of 3:1; feed temperature of 825° C., reactor pressure of 13.6 barg; 20 g of Catalyst A with Feedstock B (water feedrate=8.26 g/Hr; methane feedrate=3.33 L/Hr). These tests were conducted to demonstrate the reproducibility of the test equipment and procedures. The hydrogen yield in all four tests was analyzed and found to differ by less than 2% under the test conditions.

### Run 5

Conditions: molar steam to carbon ratio of 3:1; feed temperature of 825° C., reactor pressure of 13.6 barg; 20 g of Catalyst A with Feedstock C.

The results of the testing confirmed that high hydrogen yields could be obtained. Hydrogen yields of up to 72 mol. % were observed during Run 5 when Catalyst A was used. When the test was repeated using Catalyst B, the hydrogen yield increased to 76 mol. %. During this test, a series of ethanol samples with different denaturing agents (methanol, isopropyl alcohol, acetone, methyl ethyl ketone (MEK), ethyl acetate and benzene) were used as feedstock. When no denaturing agent was used in the feedstock, the product composition was stable over a 3 week period. The C₁ and C₃ alcohols used as denaturing agents did not appear to have much impact on the catalyst stability. However, the presence of 5 mol. % benzene or 5 mol. % MEK in the ethanol lead to a loss in H₂ production with the product gas composition dropping to between 60-65 mol. % of hydrogen (based on total product) within 24 hours of feed introduction.

### Run 6

Conditions: same as run 5 except that a molar steam to carbon ratio of 2:1 was used with Catalyst A.

During this run, a rapid loss in activity was observed due to the low molar steam to carbon ratio. When this test was repeated with Catalyst B, the loss in catalyst activity was less rapid. The catalyst regained its activity after the molar steam to carbon ratio of the feedstock was raised to 3:1.

### Run 7

Conditions: molar steam to carbon ratio of 3:1; feed temperature of 825° C., reactor pressure of 23.0 barg; 20 g of Catalyst B with Feedstock C.

It was observed that the increased pressure resulted in slightly lower hydrogen production.

### Run 8

Conditions: molar steam to carbon ratio of 4:1; feed temperature of 825° C., reactor pressure of 23.0 barg; 20 g of Catalyst B with Feedstock C.

This test was conducted in the same manner as Run 7 with the exception that a 4:1 molar steam to carbon ratio was used. The results were quite similar to the results observed in Run 7 except a slightly lower hydrogen production rate was observed due to the higher steam dilution. The closer approach to equilibrium was offset by the higher dilution of water. Over 2 weeks of testing, the hydrogen production rate did not vary more than 2 percent. It is possible that the catalyst is stable for much longer periods at these conditions.

During the runs described above, it was observed that aqueous ethanol was capable of steam reforming at steam methane reforming (SMR) conditions. The results of these experiments suggest that it is possible to co-process natural gas and ethanol mixtures for extended periods of time (at least 3 weeks) when specific denaturing agents are omitted from the ethanol. It is also possible to produce significant amounts of hydrogen from aqueous ethanol feedstock in the absence of methane or natural gas.

### Run 9

An extended stability test, Run 9, was conducted utilizing Catalyst B to determine if it was capable of operating at higher feedrates for an extended time. The testing was conducted at 200 psig (13.6 barg) using Feedstock A. The feedstock was pumped directly to the top of the micro-reactor where it was spray injected and heated to 825° C. before reaching the catalyst situated lower in the reactor tube. During the first 950 hours of testing, the top of the catalyst bed was maintained at an inlet temperature of 825° C. while processing 0.40 mL/min. of 30 wt. % aqueous ethanol. Heat was continually supplied to the reactor to maintain a temperature between 810-825° C. throughout the entire catalyst zone.

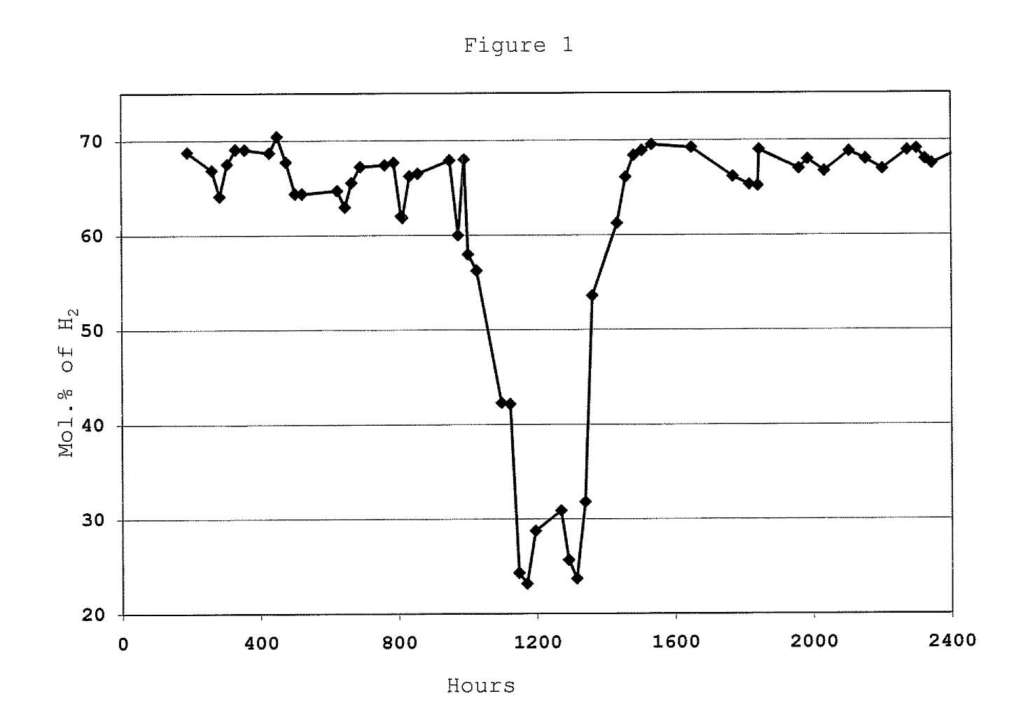

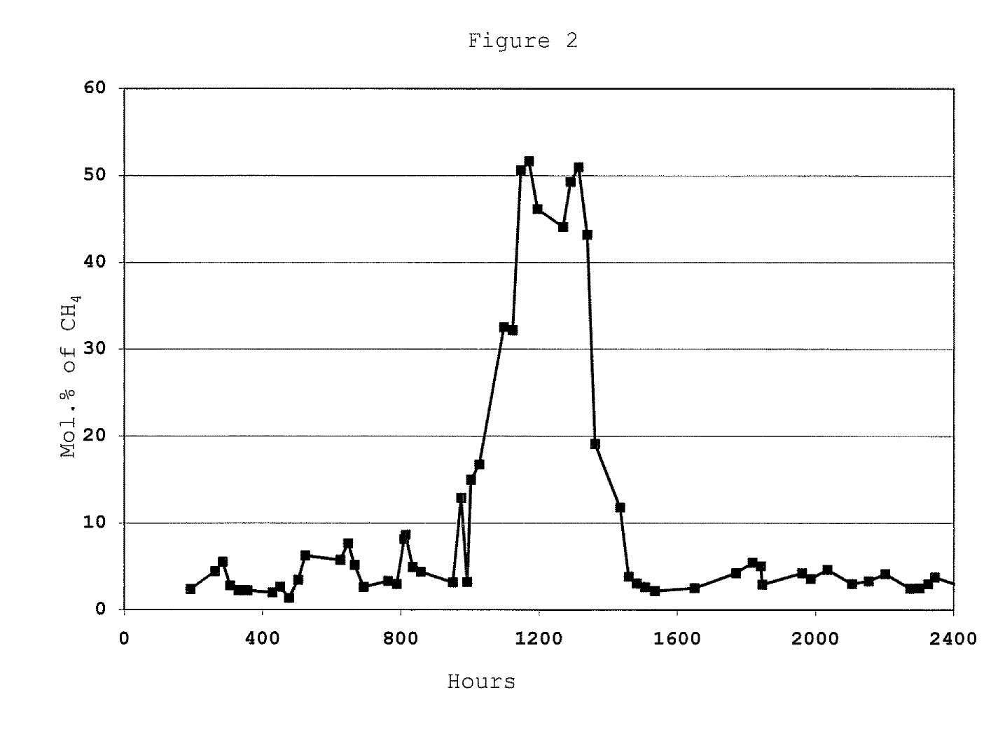

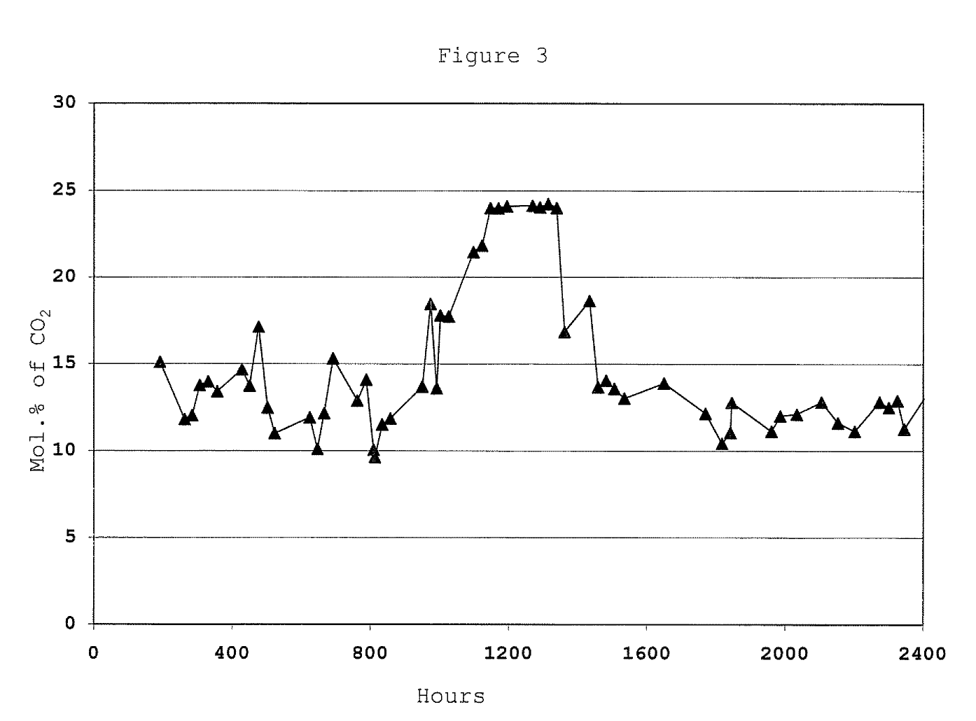

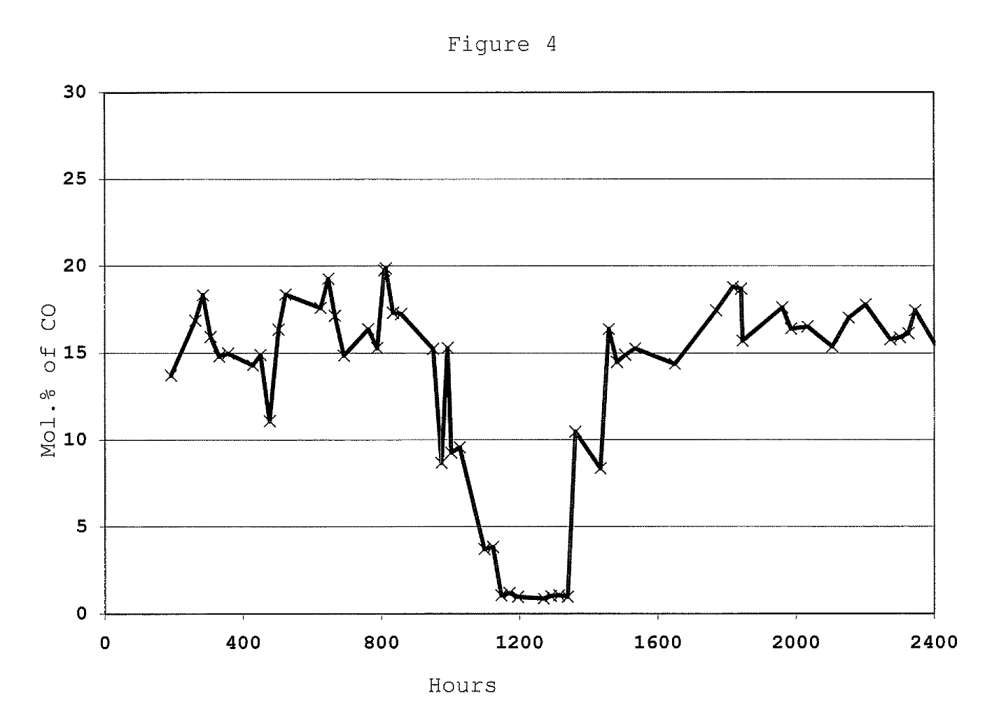

The results of the testing are shown in FIGS. 1-4. During the first 985 hours of operation, the concentration of hydrogen in the product gas ranged from just over 70 mol. % to 66 mol. % during this period. Two forced unit shutdowns occurred at 280 hours and 805 hours during the first 985 hours of testing. These two, brief process upsets were caused by electrical supply upsets that temporarily resulted in brief cooling of the catalyst and reactor. Feed pumping was stopped and nitrogen was flushed through the catalyst until electrical power was restored. Upon restarting the reactor, the performance of the catalyst returned to its previous level each time. After 480 hours of operation, a series of denatured 30 wt. % ethanol feedstocks were processed. Methanol and IPA addition had no significant impact on the performance. However, adding ethanol denatured with 5 mol. % 2-butanone MEK hexone (MIBK) or benzene led to lower hydrogen production.

After 990 hours on stream, the feed reactor temperature was lowered to 700° C. The concentration of hydrogen in the product gas declined quickly to 56 mol. % with an accompanied increase in the methane content to 17 mol. %.

The temperature was next lowered to 600° C. after 1075 hours on stream. The concentration of hydrogen in the product gas declined to 42 mol. % with an accompanied increase in the methane content to 32 mol. %.

Finally, the temperature was lowered to 500° C. after 1130 hours on stream. The concentration of hydrogen in the product gas declined to 26-30 mol. % with an accompanied increase in the methane content to around 50 mol. %.

After 1350 hours of testing, the feedrate was increased 50% to 0.8 mL/min. and the inlet reactor temperature was raised to 700° C. The conversion increased slowly back to the level achieved earlier when the reactor was operated at 700° C. The concentration of hydrogen in the product gas climbed to 54-61 mol. % with an accompanied decrease in the methane content to 12 mol. %.

After 1435 hours of testing, the inlet reactor temperature was raised back to 825° C. The conversion increased slowly back to the level achieved earlier when the reactor was operated at 825° C. The concentration of hydrogen in the product gas climbed quickly to 66-69 mol. % with an accompanied decrease in the methane content to 2-4 mol. %.

During the period 1770-1840 hours on-stream, a series of electrical power interruptions shut the unit down temporarily. After, the unit was allowed to stabilize for 8 hours, the feedrate was increased to 1.2 mL/min. for the duration of the stability study. The reactor was operated at the same test conditions during the time period of 1900 to 2403 hours on-stream and sampled regularly. After 2403 hours of operation, the product gas was sampled one final time and the unit was shut down. During the last 500 hours of operation, the catalyst activity settled back to the level achieved earlier when the reactor was operated at 825° C. but lower feedrates. The concentration of hydrogen in the product gas returned to 66-69 mol. % with a methane content to 2-4 mol. %. The CO concentration in the product during this time period stayed between 15-18 mol. %. The minimal impact of feedrate changes during the 2400 hours of operation suggests that the catalyst was operating near or at equilibrium at 825° C.

### Example 2

A dense hydrogen selective membrane reactor was prepared via the methods taught in U.S. Pat. No. 6,821,501.

A 6 inch (15.24 cm) long, 1 inch (2.54 cm) outer diameter (O.D.) section of duplex porous Inconel tube, welded to a 14 inch long by 1 inch (2.54 cm) O.D. dense, non-porous 316L stainless steel tube on one end and a 6 inch long by 1 inch (2.54 cm) O.D. dense, non-porous 316L stainless steel tube on the other end, was obtained from Mott Metallurgical Corporation. The tube was welded shut at the end of the 6 inch long 316L stainless steel tube and open at the end of the 14 inch long tube segment. The total length of the tube was 26 inches in length. The tube was cleaned in an ultrasonic bath with alkaline solution at 60° C. for 30 minutes, then rinsed with deionized water followed by isopropanol. The tube was dried in air at 120° C. for 4 hours.

A slurry of 1 μm particles, one-half of which included 1.2 wt % alloyed palladium-silver on alpha alumina eggshell catalyst and the other one-half included alpha alumina particles contained in deionized water was applied to the surface of the Inconel support (porous substrate) by means of vacuum filtration to form a layer of particles thereon and to thereby provide a porous substrate that has been surface treated.

The surface treated substrate was then coated with an overlayer of palladium by electrolessly plating the surface treated support with palladium in a plating bath containing 450 mL of palladium plating solution and 1.8 mL of 1M hydrazine hydrate solution at room temperature. The palladium plating solution included 198 ml of 28-30% ammonium hydroxide solution, 4 grams tetraaminepalladium (II) chloride, 40.1 grams ethylenediaminetetraacetic acid disodium salt, and 1 liter deionized water.

During the plating, a slight vacuum of 5-6 inches of Hg was maintained on the interior of the support for 10 minutes, after which the vacuum source was turned off and the plating continued for 90 minutes. The support was then thoroughly washed with 60° C. deionized water, and then dried at 140° C. for 8 hours. The support tube was then plated for 90 minutes at 60° C., without vacuum in 450 mL of the palladium plating solution and 1.8 mL of 1M hydrazine hydrate solution. The support tube was then thoroughly washed with hot deionized water to remove any residue salts and then dried at 140° C. for 8 hours.

The support tube was then plated two more times for 90 minutes in 450 mL of the palladium plating solution and 1.8 mL of 1M hydrazine hydrate solution at 60° C. while under a vacuum of 28-30 inches Hg that was applied to the tube side of the support. The support tube was then thoroughly washed with hot deionized water to remove any residue salts and then dried at 140° C. for 8 hours. The resulting dense, gas-selective, composite hydrogen gas separation membrane Inconel support tube had a palladium/silver layer thickness of 6 microns.

The Pd/Ag on Inconel gas separation membrane tube was incorporated into a steam reforming testing apparatus in order to evaluate its ability to produce high purity hydrogen from a variety of hydrocarbon and oxygenated hydrocarbons such as methane, acetic acid, ethanol, butanol, ethyl acetate and acetone.

An objective of the tests was to demonstrate that large amounts of high purity hydrogen could be produced while operating the steam reforming process at significantly lower reaction temperatures, (<500° C.) than are typically used in commercial steam methane reforming (>900° C.) by using a membrane reactor that allows the hydrogen produced by the steam reforming catalyst to be rapidly removed as it is made. The use of the hydrogen selective membrane permits the rapid removal of hydrogen from the reaction zone and in doing so provides an additional driving force for the steam reforming reaction. The membrane when coupled with a very high activity steam reforming catalyst allows the reforming reaction to achieve high conversions at much lower reaction temperature due to a more favorable thermodynamic equilibrium at lower reaction temperatures. The permeate produced contains high purity hydrogen with a low carbon monoxide content without the need for a separate, expensive water gas shift reaction section that is required in conventional steam methane reformers.

A second objective of the tests was to clearly show that oxygenated hydrocarbons including species derived from renewable processes could be steam reformed at very high conversion to produce large amounts of high purity hydrogen directly from the steam reforming reactor.

The Pd/Ag on Inconel gas separation membrane tube was connected inside of a 5 cm O.D. 316 stainless steel tube. The two tubes were connected in a manner to allow reagents to enter only into the 5 cm outer tube. Upon entry, the reactants were allowed to pass through a 200 g bed of catalyst B that was centered between two beds of commercially available Denstone alumina inert support balls (obtain from Saint Gobain Norpro). Catalyst B was positioned such that it was located outside the porous section of the membrane tube but fully inside the 5 cm tube. No catalyst was placed inside the gas separation membrane tube.

The steam reforming apparatus was constructed in a manner that allowed mixtures of water and methane or water and various oxygenated hydrocarbons (such as those listed above) to be added to the reactor section containing the catalyst where the steam reforming process took place. The heat for the steam reforming process was provided by a 3-zone electric tube furnace. Inside the 3-zone furnace was placed the 5 cm O.D. reactor tube that contained the dense, gas-selective, composite hydrogen gas separation membrane tube described above inside the 5 cm outer tube. Methane (99.9% purity) was supplied to the unit from a compressed gas cylinder via a mass flow controller. Distilled water and oxygenated hydrocarbons (supplied by Aldrich Chemical Co.) were supplied to the unit by means of an ISCO pump. Unreacted reagents and the products of the steam reforming reaction exited the reactor by two routes. The first route was by exiting the 5 cm tube without passing through the membrane. This is called retentate. The second route was by passing through the membrane and exiting separately through the open end of the membrane tube. This product is called permeate.

The catalyst and reactor were pressurized to 15 psig and slowly heated to 450° C. while flowing argon at 2 standard liters per minute, (SLPM). The catalyst was reduced at 450° C. by slowing reducing the argon flow and replacing it with hydrogen over a period of 2 hours. The catalyst was then contacted with the hydrogen at a flow rate of 2 SLPM for 48 hours before reaction with methane and water.

Methanol Testing: The gas separation module was tested under steam methane reforming conditions at 450° C. while operating at 270 psig with the catalyst B. The membrane displayed a hydrogen permeance in the range of from 60 to 70 m³/(m²)(hr)(bar). The selectivity was stable throughout the test period with the permeate being comprised of hydrogen with a purity of at least 98% purity.

Ethanol Testing: The steam reforming test was continued after 48 hours on stream by first stopping the flow of methane and water and then immediately feeding an aqueous ethanol stream at a rate of 100 grams per hour. The concentration of the ethanol in water was 30 wt. %. This represented a molar steam to carbon ratio of 3:1 fed to the catalyst. The hydrogen production and the selectivity to hydrogen was stable throughout the 141 hour test period with the permeate being comprised of hydrogen with a purity of at least 97.8% purity. Complete conversion of the ethanol into lighter compounds was confirmed by GC analysis of the liquid and gas products collected. After 189 hours on stream, testing continued with an aqueous ethanol feedrate of 100 grams per hour but with a molar steam to carbon ratio of 6:1 in the feedstock. A drop in hydrogen production was observed. However, the hydrogen purity in the permeate increased to at least 99.1% purity and remained stable over the next 72 hours of testing before the run was stopped. No evidence of catalyst performance decline was seen while operating with aqueous ethanol as the feedstock under the conditions examined.

Acetic Acid: Testing similar to that performed with aqueous ethanol feedstock was conducted using aqueous acetic acid and a second membrane tube prepared in an identical manner to the one prepared earlier for the steam ethanol reforming test. The testing was again begun using steam and methane at 450° C. while operating at 270 psig with the catalyst B. As before, the steam methane reforming reaction was conducted by flowing 25.8 standard liters per hour of methane and 67.3 grams per hour of deionized water over the catalyst, (a molar steam to carbon ratio of 3:1 fed to the catalyst). The new membrane displayed a hydrogen permeance in the range of from 65 to 70 m³/(m²)(hr)(bar) during the test. The pressure inside the membrane tube was maintained at 10 kPa with the aid of a vacuum pump. The hydrogen production and the selectivity to hydrogen was stable throughout the test period with the permeate being comprised of hydrogen with a purity of at least 98% purity. After 48 hours on stream, an aqueous acetic acid stream with a molar steam to carbon ratio of 6:1 was added at a rate of 100 grams per hour. The hydrogen production and the selectivity to hydrogen was stable over the 48 hour period of testing with the permeate being comprised of hydrogen with a purity of at least 97.6% purity.

Acetone: Testing similar to that performed with aqueous ethanol feedstock was conducted using aqueous acetone and a third membrane tube prepared in an identical manner to the one used earlier in the steam ethanol reforming test. The testing was again begun using steam and methane at 450° C. while operating at 270 psig with the catalyst B. As before, the steam methane reforming reaction was conducted by flowing 25.8 standard liters per hour of methane and 67.3 grams per hour of deionized water over the catalyst, (a molar steam to carbon ratio of 3:1 fed to the catalyst). The new membrane displayed a hydrogen permeance in the range of from 60 to 70 m³/(m²)(hr)(bar) during the test. The pressure inside the membrane tube was maintained at 10 kPa with the aid of a vacuum pump. The hydrogen production and the selectivity to hydrogen was stable throughout the test period with the permeate being comprised of hydrogen with a purity of at least 98% purity. After 48 hours on stream, an aqueous acetone stream with a molar steam to carbon ratio of 6:1 was added at a rate of 93.8 grams per hour. The hydrogen production and the selectivity to hydrogen was stable over the 200 hour period of testing with the permeate being comprised of hydrogen with a purity of at least 98% purity.

The results of the above tests provide clear evidence that oxygenated hydrocarbons, such as ketones, organic acids or alcohols can be steam reformed at much lower reaction temperatures than used in conventional steam methane reforming with the aid of a membrane reactor and a high activity reforming catalyst. The origin of the oxygenated hydrocarbon can be derived from fermentation of renewable feedstocks as in the production of bioethanol or from conventional synthetic petrochemical based processes. Production of hydrogen from renewable resources such as corn, wheat straw or wood may result in processes with lower overall carbon dioxide footprints.

While the foregoing is directed to embodiments of the present invention, other and further embodiments of the invention may be devised without departing from the basilicon carbide scope thereof and the scope thereof is determined by the claims that follow.

1. A bio-based feedstock steam reforming catalyst comprising:
a modified support;
a metal component; and
a promoter.

2. The catalyst of claim 1, wherein the modified support exhibits a surface area of from 20 m²/g to 300 m²/g.

3. The catalyst of claim 1, wherein the modified support is formed by contacting a support material with a modifier.

4. The catalyst of claim 3, wherein the support material comprises a transition metal oxide.

5. The catalyst of claim 3, wherein the support material exhibits a surface area of from 50 m²/g to 350 m²/g.

6. The catalyst of claim 1, wherein the metal component comprises a Group VIII transition metal in an amount of from 0.1 wt. % to 60 wt. %.

7. The catalyst of claim 1, wherein the metal component comprises nickel.

8. The catalyst of claim 3, wherein the modifier comprises an alkaline earth element in an amount of from 0.1 wt. % to 15 wt. %.

9. The catalyst of claim 3, wherein the modifier comprises a magnesium containing compound.

10. The catalyst of claim 1, wherein the promoter comprises a rare earth element in an amount of from 0.1 wt. % to 15 wt. %.

11. The catalyst of claim 1, wherein the promoter comprises lanthanum.

12. The catalyst of claim 3, wherein the steam reforming catalyst comprises a greater amount of promoter than modifier.

13. A method of preparing a bio-based feedstock steam reforming catalyst comprising:
providing a support material comprising a transition metal oxide;
providing a modifier comprising an alkaline earth element;
contacting the support material with the modifier to form a modified support;
providing a metal component comprising a Group VIII transition metal;
contacting the support material, the modified support or combinations thereof with the metal component to form the steam reforming catalyst; and
contacting the modified support, the metal component, the steam reforming catalyst or combinations thereof with a promoter.

14. The method of claim 13 further comprising calcining the steam reforming catalyst, the modified support or combinations thereof at a calcining temperature of from 400° C. to 900° C.

15. The method of claim 14, wherein the modified support exhibits a greater surface area after calcining than before.
